(19) United States
(12) Patent Application Publication
(10) Pub. No.: US 2013/0145872 A1
(43) Pub. Date: Jun. 13, 2013

(54) POWER TRANSFER DEVICE

(71) Applicant: Bruce D. Feltenberger, Clinton, OH (US)

(72) Inventor: Bruce D. Feltenberger, Clinton, OH (US)

(21) Appl. No.: 13/579,157

(22) PCT Filed: Feb. 17, 2011
(86) PCT No.: PCT/US2011/025193

§ 371 Date: Nov. 12, 2012

Related U.S. Application Data
(60) Provisional application No. 61/305,232, filed on Feb. 17, 2010.

(51) Int. Cl. F16H 25/12

(52) U.S. Cl. CPC F16H 25/12
USPC 74/89.34

(57) ABSTRACT

A power transfer device may include a support assembly, a bearing assembly, and an axle that has at least one groove that is angled in a predetermined manner. A guide pin may be received within the groove. Rotation of the axle may then cause a linear input to be received by an output component attached to the end of the axle.

### I. BACKGROUND

A. Field of Invention

It is well known that the shortage of clean drinking water and adequate supplies of water for irrigation and sanitation are very big problems worldwide. This is prevalent especially in so called “under developed” countries and also in general for any isolated or remote area where there is limited or no access to electricity or fuels such as gasoline or diesel. In areas such as these, it is too often common to find people drinking contaminated water, going hungry due to the lack of water to irrigate their crops and/or living in deplorable conditions due to the lack of water and pumping capability to provide adequate sanitation.

B. Description of the Related Art

In under developed countries, there does not appear to be a suitable manually operated pumping system that can lift surface water from rivers, creeks, lakes, ponds or shallow wells a distance up to 25 feet or so from the source water to the pump by a suctioning process, pressurize the water and pump it through filtration or reverse osmosis systems to produce clean drinking water.

Similarly, there are significant areas in the world with little or no access to surface water, electricity or fuels where the ability to pump water manually from deep wells may be desirable. If the wells are deep enough, they may produce clean drinking water without filtration, otherwise, the water may need to be pumped to the surface and then pressurized and filtered.

Deep water pumping systems such as those our forefathers used for pumping water from wells, may from time to time, on a limited basis, produce small amounts of clean drinking water, but they cannot produce the volume of clean water that is needed for large numbers of people or for irrigation or sanitation.

Most manually-operated (usually hand-operated) pumping systems that have been tried or used over many years are extremely difficult to operate in a sustained manner. This typically results in extreme operator fatigue and discouragement. A variety of manually operated pumping systems have been tried over the years; however, none have emerged with the characteristics that are needed to solve water related problems on a wide spread scale. This is evidenced by the fact that, generally speaking, access to clean drinking water is no less of a problem today than it has ever been.

Additionally, in many areas throughout the world where there is little or no access to electricity or fuels, there is also little or no access to surface water or wells. In areas like these, a manually operated device that could drill deep wells in search of clean drinking water would be very desirable.

Finally, aside from water related issues, in the areas of the world where there is little or no access to electricity, a device, which could be operated manually in a sustainable manner to produce small scale electricity generation with minimal operator fatigue, would be very useful.

Consequently, a need has been felt to provide a manually operated machine, which is easy to operate in a sustainable manner while keeping operator fatigue to a minimum. The instant invention provides such a machine that can be used to power a number of different devices. By coupling the horizontal axle to the appropriate reciprocating pump, it can be used for pumping water from shallow or deep sources, pressurize the water, pump the water through a filtration or reverse osmosis system to produce clean drinking water, or pump larger volumes of

water that do not require filtration as in the case of irrigation or sanitation. By changing output components, the instant invention becomes a multitask machine, which can be coupled to a linkage system to rotate a flywheel, winch for drilling wells, a generator for small scale electricity generation and other uses chosen with the sound judgment of a person of skill in the art.

### II. SUMMARY

It is therefore, an object of the present invention to provide an improved power transfer device.

A feature of the present invention according to one embodiment is to provide an improved power transfer device utilizing rotational motion to impart the working force.

Features of the present invention according to other embodiments are to provide an improved power transfer device whereby the rotational motion used to impart the working force can be either constant rotation in one direction or it can be oscillating rotational motion such as would result from an oscillating pendulum describing successive arcs of less than 360 degrees.

Briefly described according to one embodiment of the present invention, a rigid arm pendulum may be combined with an axle to provide rotary oscillation and linear oscillation wherein the pendulum and the axle together oscillate in a linear direction while the pendulum rotates. A handle may be provided, which is rigidly fastened to the end of the axle nearest the pendulum, to enable one or more persons to push the pendulum to keep it in motion.

In operation, the pendulum can describe relatively low over and back arcs, which, if compared to the face of a clock might be from 4 o'clock to 8 o'clock, or it can describe higher arcs, say from 1 o'clock to 11 o'clock, If desired, the pendulum can be pushed all the way around so that it spins, or rotates, continually in one direction. As the pendulum is caused to rotate either continually or in an oscillating manner, the pendulum and the pendulum axle may oscillate in a linear direction along the longitudinal centerline of the axle.

The end of the axle opposite the handle may be attached to the piston rod of a reciprocating piston pump and the pump may be plumbed such that as the pendulum rotates, the piston rod is driven in and out, which causes a pumping action. Numerous fluids can be pumped although the present invention is well suited for pumping water.

The distance the piston rod moves in and out of the pump may be determined by the lead angle of the groove on the axle that is engaged by a guide pin. In one embodiment, a plurality of grooves may he provided, each having a different lead angle so that the distance the piston rod travels can change by inserting the same guide pin (or another guide pin) in a different groove. In this manner, one full rotation of the axle can be caused to pump a greater or lesser amount of fluid when one considers that the volume of fluid displacement is determined by the distance the piston travels. Also, if the effort or energy provided by the operator(s) is kept more or less constant regardless of the lead angle on the groove being used, the pressure (measured, for example, in pounds per square inch, PSI) will change along with the volume. As is known by those of skill in the art, the greater the volume, the lower the pressure, and vice versa.

Furthermore, with this arrangement, if the operator wishes to maintain a given pressure being pumped, but also wishes to push the pendulum less vigorously, the same guide pin (or another guide pin) can be inserted into a groove with a smaller lead angle to produce less volume. Another option is to push the pendulum at a smaller included angle while using any of the grooves. This results in less volume being pumped and therefore less effort required for pushing the pendulum. The converse would also be true, if the operator wishes to pump a greater volume, the pendulum arc can be increased or a groove with a larger lead angle can be used or a combination of both.

A prototype of the present invention utilizing a pendulum and a handle to facilitate pushing the pendulum manually (by hand) has been constructed and the process of pushing the pendulum to pump water has been evaluated and compared to driving the pump with a lever arm requiring a push-and-pull type of activity. Both were operated by hand while pumping the same volume of water at the same pressure. As would be expected, it was found in both experiments that the input required to produce the same output was equal; however, from a fatigue standpoint, it was easier physically to apply the input effort to a moving pendulum, which has greater speed than a simple lever arm. Furthermore, it was found by varying the length of the pendulum arm, the pendulum weight and the length of the arm on the handle being pushed, to achieve an optimum relationship, that the operator pushing the pendulum to drive the pump could out-perform an operator pushing and pulling the lever arm to drive the pump by approximately five to one. Because it was easier to impart the driving force in a rotary fashion to a moving pendulum and because of the unbalanced condition found in a rigid arm pendulum, the operator could last about five times longer before fatigue set in and this resulted in pumping about five times as much water at the same pressure.

Similarly, if the horizontal pendulum axle is connected to a linkage to drive a flywheel, which in turn can be used to drive a winch, generator, or other forms of rotating equipment, it is easier physically to impart the driving force to the pendulum to drive these devices due to the pendulum speed and the unbalanced condition than it is to simply turn a crank to drive the flywheel. Therefore, an advantage of the present invention is that it provides an easily adapted means of powering mechanical, hydraulic or electrical equipment by hand while incurring greatly reduced operator fatigue compared to other conventional means such as the lever arm or hand crank.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a side view of the primary components according to one conceptual embodiment of the present invention.

FIG. 2 is a top view of the power transfer device of FIG. 1.

FIG. 3 is a side view showing the axle connected to the piston rod in a piston pump.

FIG. 4 is a top view of the power transfer device of FIG. 3.

FIG. 5 is a side view showing the power transfer device of FIG. 3 mounted to a base frame with a pendulum and handle attached to the axle.

FIG. 6 is a front view of the power transfer device of FIG. 5.

FIG. 7 shows a top view of an embodiment of a sleeve

FIG. 8 is a side view of the sleeve of FIG. 7.

FIG. 9 is a side view of a guide pin.

FIG. 10 is a top cut-away view of another embodiment showing a rotary pin holder and guide pin.

FIG. 11 is a side sectional view of the rotary pin holder shown in FIG. 10.

FIG. 12 is an end view of the rotary pin holder of FIG. 11.

FIG. 13 is a top view of a power transfer device.

FIG. 14 is a side view of the power transfer device of FIG. 13.

FIG. 15 is a close up view of a portion of the axle shown in FIG. 1.

### IV. DETAILED DESCRIPTION

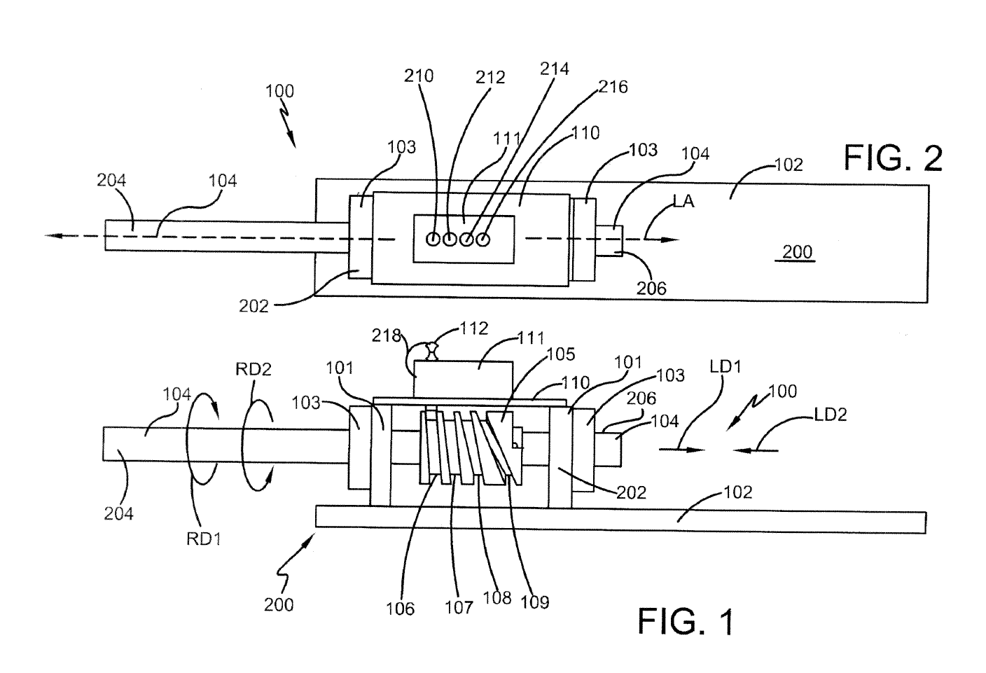

FIG. 1 and FIG. 2 show a side view and top view respectively of a power transfer device 100 according to one embodiment of this invention. The power transfer device 100 may include a support assembly 200, a bearing assembly 202 supported to the support assembly 200, and an axle 104 that is received within the bearing assembly 202. The support assembly 200 may be of any design chosen with the sound judgment of a person of skill in the art. For the embodiment shown in FIGS. 1-2, the support assembly 200 may include a base plate 102 and a support plate 110. The support assembly 200 may also include a pin holder 111 that is supported to the support plate 110 and used for purposes described below. While the bearing assembly 202 can be of any type and size chosen with the sound judgment of a person of skill in the art, for the embodiment shown it may include two linear bearing blocks 101 rigidly attached to the base plate 102. Linear bearings 103 may be secured to the bearing blocks 101 in any suitable manner.

With continuing reference to FIGS. 1 and 2, the axle 104 may have first and second ends 204, 206 and a longitudinal axis LA. The axle 104 may be received within the bearings 103 and may be suitable to be rotated within the bearings 103 in both a first rotational direction RD1 and a second rotational direction RD2 that is opposite the first rotational direction RD1. The axle 104 may also be suitable to be longitudinally moved (slid) within the bearings 103 in a first linear direction LD1 and a second linear direction LD2 that is opposite the first linear direction LD1. The axle 104 may have at least one groove, four grooves 106, 107, 108, 109 shown, formed on its outer surface. In one embodiment, the groove(s) is formed on the axle 104 itself. In another embodiment, shown, a sleeve 105 may be securely fastened to the axle 104 (thereby becoming an outer surface of the axle 104) and the sleeve 105 may have the groove(s) formed thereon.

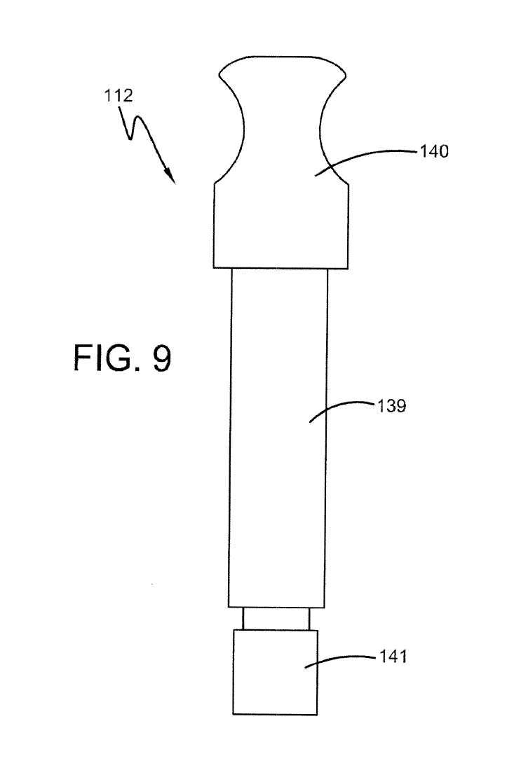

Still referring to FIGS. 1 and 2, the pin holder 111 may be used to hold one or more guide pins 112. The pin holder 111 may be fixed to the support plate 110 and may have one opening for each groove formed on the axle 104. FIG. 9 shows a side view of one embodiment of a guide pin 112 that engages the grooves. The guide pin 112 may include a handle 140 and a body 139. The handle 140 and body 139 may be made from a single integral piece of steel. The body 139 may engage the stationary pin holder 111 and it may not rotate during operation. A track roller 141 may be fastened to the end of the body 139 in such a way as to allow the track roller 141 to rotate while it engages any one of the grooves. The track roller 141 may be the only part of the pin that engages the grooves. For the embodiment shown in FIGS. 1-2, openings 210, 212. 214, and 216 correspond to grooves 106, 107, 108. 109. A guide pin 112 may adjusted into an engagement position where it extends through an opening and is received in the corresponding groove. The guide pin 112 may also be adjusted into a neutral position where no guide pin is received in any groove. The benefit of this neutral position will be described below. It should be understood that the number of guide pins used with this invention can be any chosen with the sound judgment of a person of skill in the art. For the embodiment shown, a single guide pin 112 is used for each opening 210, 212, 214, 216 and corresponding groove 106, 107, 108, 109. FIG. 1 shows the guide pin 112 is in an engagement position where it extends through opening 210 and is received in groove 106. To adjust the guide pin 112 into an alternate engagement position, it is removed from the groove 106 and opening 210 and then extended into another opening 212, 214. 216 and its corresponding groove 107, 108, 109, respectively. In another embodiment, multiple guide pins may be used. In one non-limiting example, to adjust the power transfer device 100 from groove 106 to groove 107, the guide pin 112 is removed from the groove 106 and opening 210 and another guide pin (not shown) is extended into opening 212 and is received in groove 107. As will be understood by those of skill in the art, any number of guide pins may be used as desired. If desired, the guide pin(s) may be loosely attached to the power transfer device 100 with a cord or chain 218. By “loosely attached” it is meant that the guide pin can be easily moved into and out of the opening(s) and groove(s) yet remains attached to the power transfer device 100. This prevents misplacement of the guide pin(s).

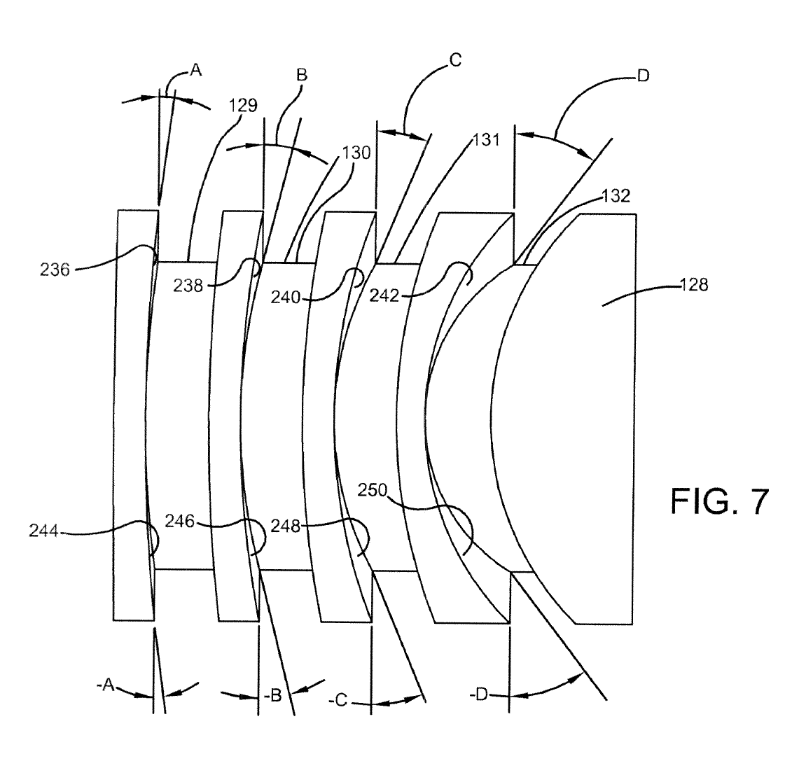

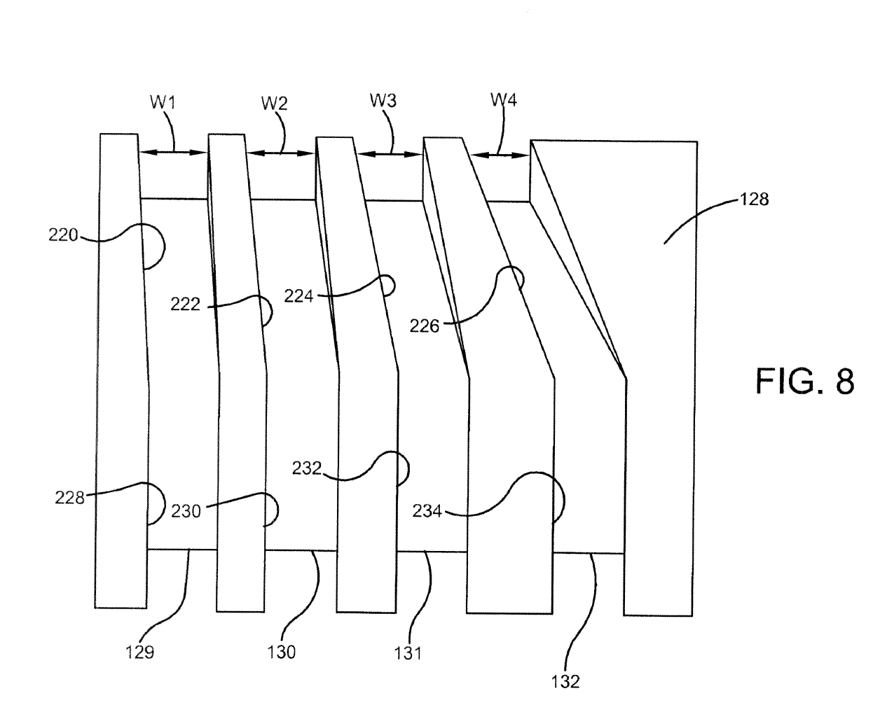

With reference now to FIGS. 1, 7, 8, and 15, each groove may be shaped and sized in any manner chosen with the sound judgment of a person of skill in the art. In one embodiment, shown in FIG. 15, at least a portion of the groove 106 is angled at an angle A with respect to a line that: intersects the longitudinal axis LA of the axle and; is perpendicular to the longitudinal axis of the axle. The grooves 107, 108 and 109 may similarly have at least a portion angled at angles B, C and D, respectively, as shown. In one embodiment, these angles A, B, C and D are significantly different from each other. For the embodiment shown in FIG. 15, each groove is oval shaped and extends 360 degrees around the axle 104. In another embodiment, shown in FIG. 8, while one portion 220, 222, 224, 226 of each groove 129, 130, 131, 132 is angled, another portion 228, 230, 232, 234 is not angled. The angled and non-angled portions may extend any amount of the groove required by the designer. In one non-limiting example, the angled portions may extend for 180 degrees around the axle 104 and the non-angled portions may also extend for 180 degrees around the axle 104. In yet another embodiment, shown in FIG. 7. while one segment 236, 238, 240, 242 of each groove 129, 130, 131, 132 is angled at angles A, B, C, D another segment 244, 246, 248, 250 of each groove is angled at equal but opposite angles −A, −B, −C, −D. For the embodiment shown in FIG. 7, each segment extends for 90 degrees around the axle 104. It should be clear that the number of groove portions/segments and their angles can be determined by the designer to meet the specific needs of a particular use. With reference now to FIG. 8, it is also contemplated to vary the widths W1, W2, W3, W4 of the grooves both between grooves and within the some groove as determined by the designer.

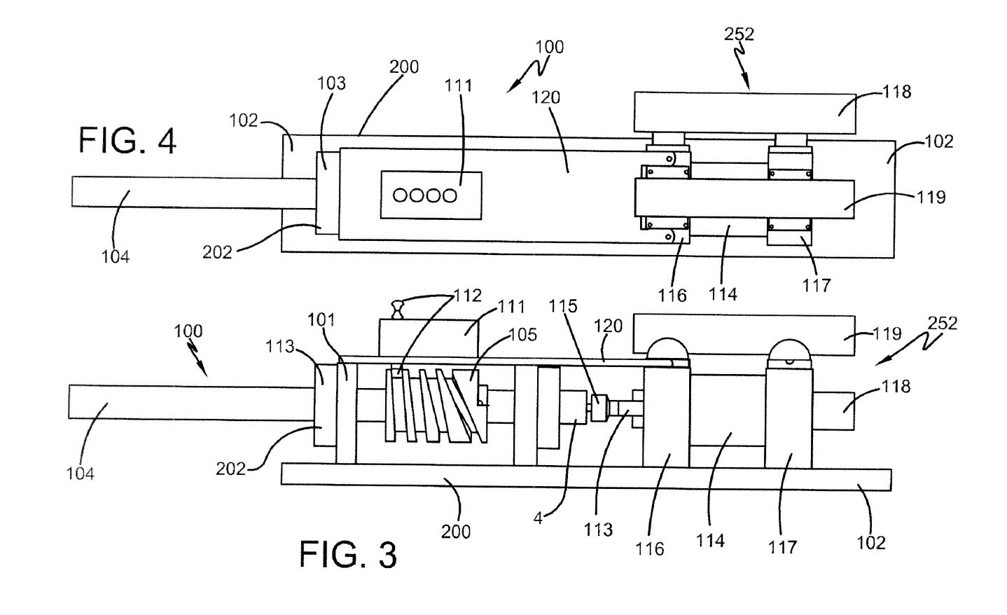

With reference now to FIGS. 1-8 and 13-15, the operation of the power transfer device 100 will now be described. In essence, the power transfer device 100 is used to convert rotary motion to linear motion in transferring power. An input component 152 (illustrated in FIGS. 5-6 and 13-14) is operatively attached to the first end 204 of the axle 104 and an output component 252 (illustrated in FIGS. 3-5) is operatively attached to the second end 206 of the axle 104. The particular devices used as the input and output components 152, 252 can be any chosen with the sound judgment of a person of skill in the art. Non-limiting examples of an output component 252 include: the piston rod of a reciprocating piston pump, the diaphragm rod of a reciprocating diaphragm pump or a system of linkages arranged in a locomotive style to provide rotation to a flywheel, which can be coupled to an electric generator, winch or a well drilling rig. In one embodiment, shown in FIGS. 3-6, the output component 252 is a piston pump 114. The axle 104 is connected to a piston rod 113 in the piston pump 114. A ball swivel joint 115 may be provided to compensate for potential misalignment between the axle 104 and the piston rod 113. Cylinder end caps 116 and 117 may be provided as integral parts of the piston pump and may be rigidly secured to the base plate 102. An intake manifold 118 may be secured to the cylinder end caps 116 and 117 to facilitate plumbing from the pump to the water source (not shown). An outlet manifold 119 may be secured to the cylinder end caps 116 and 117 to facilitate plumbing from the pump to a filtration system, water tank or other devices as may be desired. The support plate 110 may be replaced by a longer support plate 120 that provides rigidity to the entire system by connecting the bearing blocks 101 to the cylinder end cap 116.

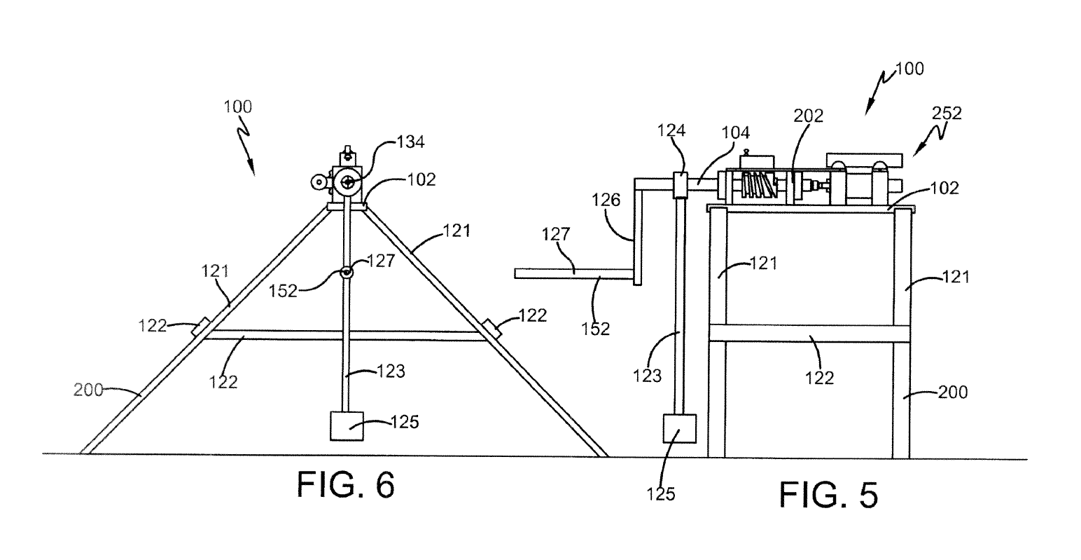

With reference now to FIGS. 5-6, the support assembly 200 may include a base frame comprised of legs 121 and leg support members 122. A pendulum arm 123 may be rigidly fastened to the horizontal axle 104 via a clamp ring 124 and a pendulum weight 125 may be secured to the end of the pendulum arm. The input component 152 for this embodiment may be a handle 127 supported to the axle 104 via support arm 126. The handle 127 may be used to provide a manual input to the power transfer device 100 and it may be mounted to the handle support arm 126 in such a way as to be adjustable regarding its distance from axle 104. Other input components 152 are also contemplated. Non-limiting examples include: an electric motor, an internal combustion engine or the like, a bicycle type drive system and a balanced or unbalanced flywheel.

With reference now to FIGS. 1-9 and 13-15, once the input and output components 152, 252 are attached to the axle 104, the guide pin 112 is then placed into an engagement position where it is received within a groove. When the first end 204 of the axle 104 is then rotated by the input component 152, the second end of the axle 206 causes the output component 252 to receive an input. The input received by the output component 252 depends on the specific design of the groove that is engaged and on the specific rotation provided to the axle 104 by the input component 152. The rotation provided may be continual rotation in one rotational direction, or in another embodiment, alternating continual rotation in one rotational direction followed by continual rotation in the opposite rotational direction or, in yet another embodiment, may include partial rotation (less than 360 degrees) in one rotational direction followed by partial rotation (less than 360 degrees) in the opposite rotational direction.

With continuing reference to FIGS. 1-9 and 13-15, if the guide pin 112 is received within a portion of the groove that is at a non-zero angle, then rotation of the axle 104 will cause the output component 252 to receive a linear motion input. The direction and amount of linear motion input received will depend on the specific angle of that portion of the groove. If the guide pin 112 is received within a portion of the groove that is at a zero angle (such as portion 228 shown in FIG. 8), then rotation of the axle 104 will cause the output component 252 to receive no linear motion input. If the guide pin 112 is received within a segment of the groove that is at a relatively positive angle (such as segment 236 angled at angle A shown in FIG. 7), then rotation of the axle 104 will cause the output component 252 to receive a linear motion input in a first direction (first linear direction LD1, for example). Continued rotation of the axle 104 when the guide pin 112 is received within a segment of the groove that is at a relatively negative angle (such as segment 244 angled at angle −A shown in FIG. 7), will cause the output component 252 to receive a linear motion input in a second opposite direction (second linear direction LD2, for example). If the guide pin 112 is received within a groove that is at a relatively smaller angle (such as groove 106 at angle A as shown in FIG. 15), then rotation of the axle 104 will cause the output component 252 to receive a linear motion input a first linear amount. If the guide pin 112 is then removed from the groove 106 and then inserted (or another guide pin is inserted) into another groove that has a relatively larger angle (such as groove 107 at angle B as shown in FIG. 15), then rotation of the axle 104 will cause the output component 252 to receive a linear motion input a second linear amount that is greater than the first linear amount. As is clear to a person of skill in the art, the possible design variations are nearly endless.

With reference now to FIGS. 1-6 and 13-14, as noted above, the neutral position occurs when all guide pins are removed from all grooves. In this case, rotation of the axle 104 any amount will cause the output component 252 to receive no linear motion input. This neutral position can be helpful, for example, in diagnosing a problem. If, for example, the power transfer device 100 is attached to the piston pump 114 (FIGS. 3-4) and the operation is not proper, the power transfer device 100 can be placed into the neutral position. The neutral position effectively detaches the piston pump 114 from the power transfer device 100. Thus, if the axle 104 is then rotated while in the neutral position, it can easily be determined if the problem is with the power transfer device 100 or the piston pump 114.

With reference now to FIGS. 1-8 and 15, the grooves 129, 130, 131, and 132 may have portions with angles that extend 90 degrees around the sleeve 128 (and thus the axle 104) in either direction and then no angle for 180 degrees around the sleeve. When one of these grooves is engaged by the guide pin 112, it results in linear oscillation of the axle in one direction for 90 degrees of rotation of the axle, and then the linear direction of the axle reverses during the next 90 degrees of rotation of the axle in the same direction. The next 180 degrees of continuous rotation of the axle in the same direction results in no linear oscillation (no linear input). By properly orienting sleeve 128 on axle 104 in relation to the pendulum arm 123 and guide pin 112, this arrangement can provide for linear oscillation of the pendulum as it rotates or falls from top center to bottom center and does not allow linear oscillation of the pendulum during its upward stroke. In this manner, the pendulum can be caused to do work only on the down stroke. but not on the up stroke. Based on the preference of the designer and the specific application contemplated, the angles of the grooves can extend greater or less than 180 degrees around the axle, which results in a greater or lesser portion of rotation of the axle that produces linear movement. If for instance, it is desired to produce work only during a portion of the down stroke of the pendulum, the angles on the grooves can extend less than 180 degrees around the axle and the portion of the grooves with no angles can extend greater than 180 degrees.

With reference now to FIGS. 1-6 and 13-15, when the axle 104 is rotated while the guide pin 112 is received in a non-zero angled portion of a groove, the axle 104 is caused to slide along its longitudinal centerline. As noted above, the distance the axle slides is determined by the angle that the corresponding groove makes with the longitudinal centerline of the axle. It can be seen in FIG. 15 that for a very small amount of longitudinal travel, the guide pin 112 can be inserted to engage groove 106, which has a relatively small angle. For the maximum linear travel or input, the guide pin 112 (or another guide pin) can be inserted into groove 109, which has a relatively much larger angle. As the axle is rotated 180 degrees, the axle slides in a linear direction along its longitudinal centerline and as the axle continues to rotate another 180 degrees in the same direction, the axle reverses its linear direction and slides back to its original starting point, This produces axial linear oscillation, while constantly rotating the axle in one direction; however, axial linear oscillation is also achieved by intermittently reversing the direction of rotation of the axle such as would occur if the axle were driven by a rigid arm pendulum.

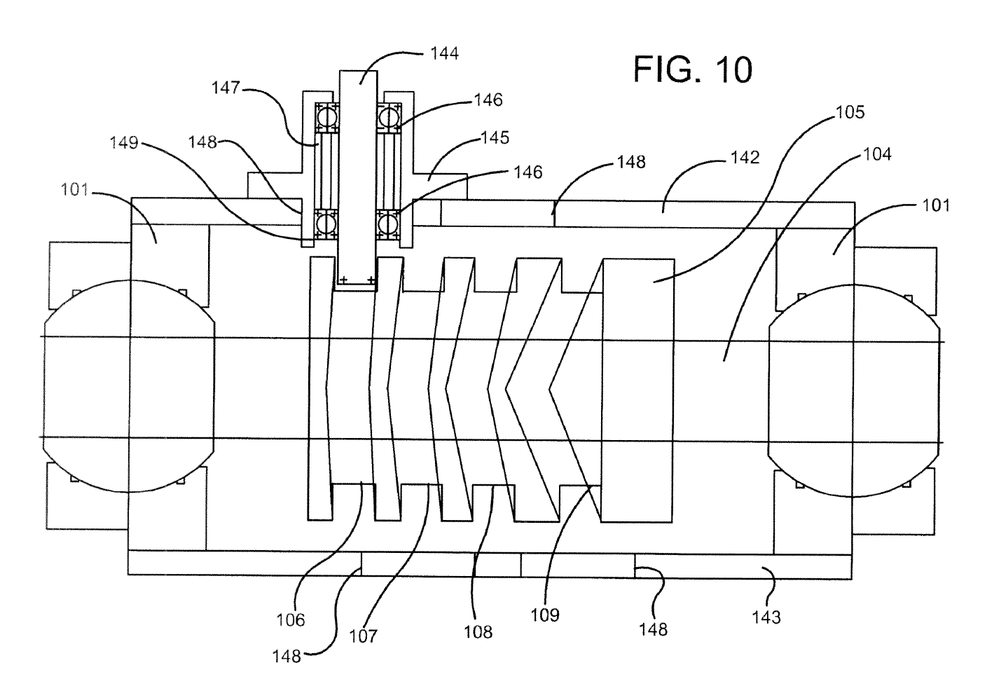

FIG. 10 shows another embodiment. It shows a top view of the axle 104, the sleeve 105 and a rotatable guide pin 144. Side plates 142 and 143 are secured to bearing blocks 101. Two holes 148 are provided in each side plate to accommodate locating the rotary pin holder 145 in relation to the grooves on sleeve 105. Two bearings 146 provide a precise location and a rotary capability to the rotatable guide pin 144, which may be made of a single piece of steel. A tubular bearing sleeve 147 separates the bearings 146. A snap ring can be inserted into groove 149 to further restrain the bearing nearest the groove sleeve. The guide pin is shown engaging groove 106. The rotary guide pin holder 145 can be removed from side plate 142 and inserted into hole 148 to enable the rotatable guide pin 149 to engage groove 108. Similarly, the rotary guide pin holder can be inserted into holes 148 in side plate 143 to enable the guide pin to engage either groove 107 or 109.

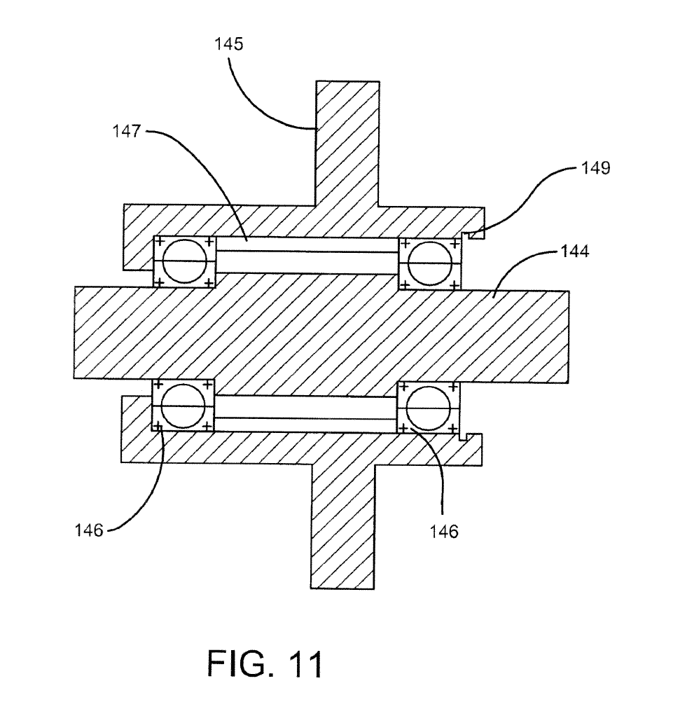

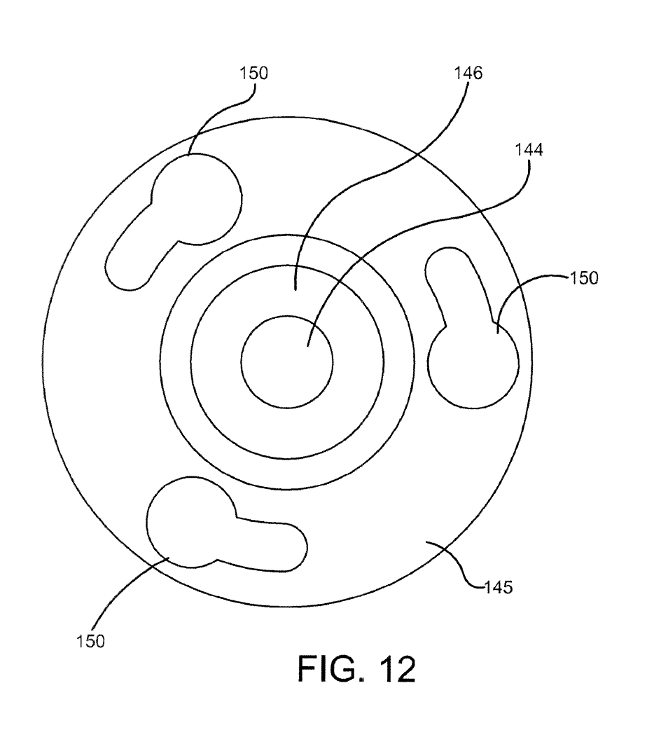

FIGS. 11 and 12 show a sectional view and an end view respectively of the rotary pin holder 145 and the rotatable guide pin 144. Three slots 150 are shown to facilitate securing the rotary pin holder to the side plates 142 or 143. Screws or bolts can be added to the side plates such that the rotary pin holder can be installed into a hole 148 and the large end of the slots 150 will fit over the heads of the screws or bolts. A small clockwise turn of the rotary pin holder will position it to be secured by tightening the screws or bolts.

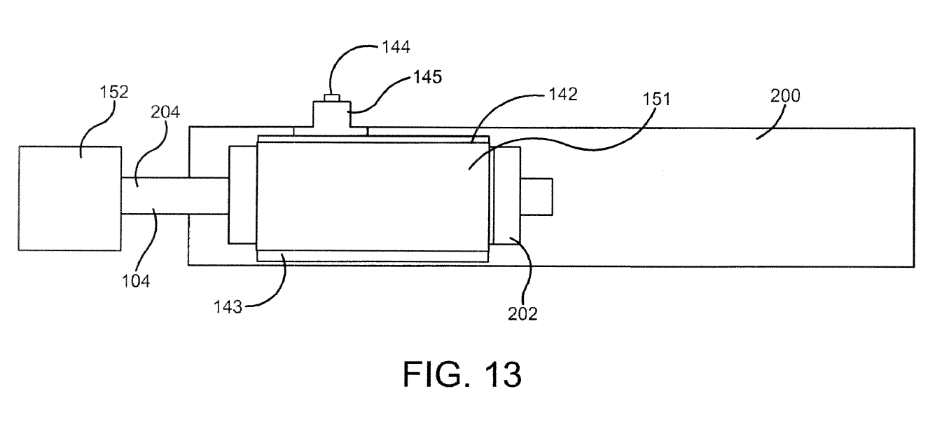

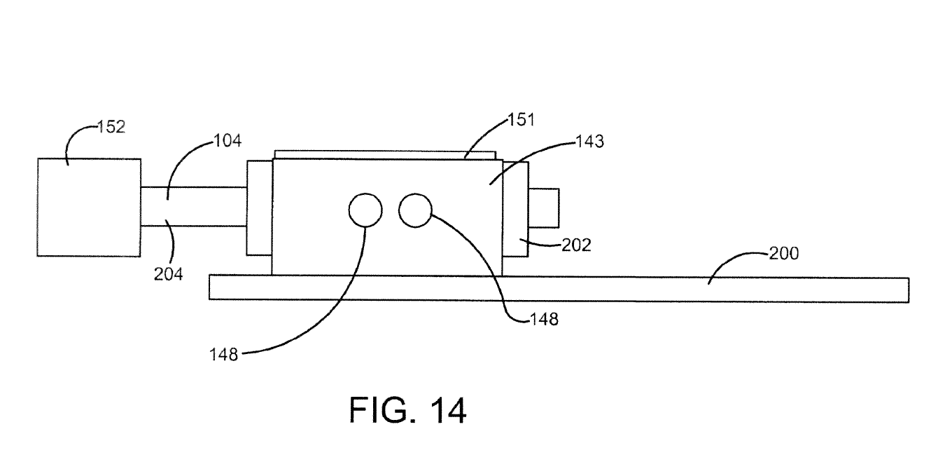

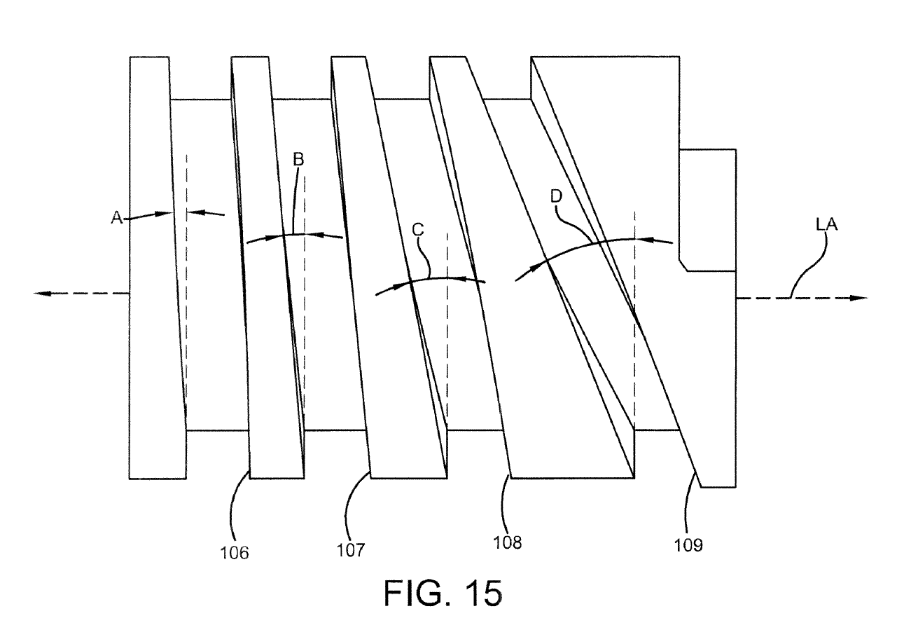

FIGS. 13 and 14 show a top view and a side view respectively of the rotary pin holder 145 and side plates 142 and 143. A top cover 151 is shown to provide rigidity and a power input device 152 is shown to represent numerous types of input devices that could be used such as discussed above.

Numerous embodiments have been described, hereinabove. It will be apparent to those skilled in the art that the above methods and apparatuses may incorporate changes and modifications without departing from the general scope of this invention. It is intended to include all such modifications and alterations insofar as they come within the scope of the appended claims or the equivalents thereof.

Having thus described the invention, it is now claimed:

What is claimed:

1. A power transfer device comprising:
a support assembly comprising first and second openings;
a bearing assembly supported to the support assembly;
an axle that: (1) has first and second ends; (2) has a longitudinal axis; (3) is suitable to be rotated within the bearing assembly in a first rotational direction and a second rotational direction that is opposite the first rotational direction; (4) is suitable to be longitudinally moved within the bearing assembly in a first linear direction and a second linear direction that is opposite the first linear direction; (5) has a first groove on its outer surface, wherein at least a portion of the first groove is angled at an angle A with respect to a line that: (a) intersects the longitudinal axis of the axle and; (b) is perpendicular to the longitudinal axis of the axle; and, (6) has a second groove on its outer surface, wherein at least a portion of the second groove is angled at an angle B with respect to the line that is significantly different than angle A;
an input component operatively attached to the first end of the axle;
an output component operatively attached to the second end of the axle;
a first apparatus that is adjustable into a first engagement position where the first apparatus extends through the first opening in the support assembly and is received within the first groove in the axle;
a second apparatus that is adjustable into a second engagement position where the second apparatus extends through the second opening in the support assembly and is received within the second groove in the axle;
wherein when the first apparatus is in the first engagement position, rotation of the first end of the axle by the input component in the first rotational direction causes the output component to receive from the second end of the axle a first linear motion input in the first linear direction a first linear amount; and,
wherein when the second apparatus is in the second engagement position, rotation of the first end of the axle by the input component in the first rotational direction causes the output component to receive from the second end of the axle a second linear motion input in the first linear direction a second linear amount that is significantly different than the first linear amount.

2. The power transfer device of claim 1 wherein:
when the first apparatus is in the first engagement position, rotation of the first end of the axle by the input component in the second rotational direction causes the output component to receive from the second end of the axle a third linear motion input in the second linear direction a third linear amount; and,
when the second apparatus is in the second engagement position, rotation of the first end of the axle by the input component in the second rotational direction causes the output component to receive from the second end of the axle a fourth linear motion input in the second linear direction a fourth linear amount that is significantly different than the third linear amount.

3. The power transfer device of claim 2 wherein the power transfer device further comprises:
a pendulum arm that extends from the first end of the axle;
a pendulum weight secured to a distal end of the pendulum arm;
wherein the input component is a handle attached to the first end of the axle that is suitable for manual rotation of the axle in the first and second rotational directions; and,
wherein the output component is a piston pump.

4. The power transfer device of claim 3 wherein:
each of the first and second grooves is substantially oval shaped and extends 360 degrees around the axle.

5. The power transfer device of claim 3 wherein:
the first groove: (1) extends 360 degrees around the axle; (2) has a first portion that is angled at the angle A with respect to the line; and, (3) has a second portion that is not angled with respect to the line;
when the first apparatus is in the first engagement position, rotation of the first end of the axle by the input component in the first rotational direction a first rotational distance while the first apparatus is received in the first portion of the first groove causes the piston pump to receive the first linear motion input; and,
when the first apparatus is in the first engagement position. rotation of the first end of the axle by the input component in the first rotational direction an additional rotational distance while the first apparatus is received in the second portion of the first groove causes the piston pump to receive no linear motion input from the second end of the axle.

6. The power transfer device of claim 5 wherein:
a vertical plane defines first and second sides of the axle;
the first groove is oriented such that the first portion is positioned on the first side of the axle and the second portion is positioned on the second side of the axle;
the first portion of the first groove has first and second segments, wherein the first segment is angled with respect to the line at the angle A and the second segment is angled with respect to the line at an angle −A;
when the first apparatus is in the first engagement position, rotation of the first end of the axle by the input component in the first rotational direction a first part of the first rotational distance while the first apparatus is received in the first segment of the first portion of the first groove causes the piston pump to receive the first linear motion input in the first linear direction; and,
when the first apparatus is in the first engagement position, rotation of the first end of the axle by the input component in the first rotational direction a second part of the first rotational distance while the first apparatus is received in the second segment of the first portion of the first groove causes the piston pump to receive a fifth linear motion input in the second linear direction.

7. A power transfer device comprising:
a support assembly comprising a first opening;
a bearing assembly supported to the support assembly;
an axle that: (1) has first and second ends; (2) has a longitudinal axis; (3) is suitable to be rotated within the bearing assembly in a first rotational direction; (4) is suitable k/be longitudinally moved within the bearing assembly in a first linear direction; and, (5) has a first groove on its outer surface, wherein at least a portion of the first groove is angled at an angle A with respect to a line that: (a) intersects the longitudinal axis of the axle and; (b) is perpendicular to the longitudinal axis of the axle;
wherein the first end of the axle is suitable to receive an input from an associated input component;
wherein the second end of the axle is suitable to provide an output to an associated output component;
a first apparatus that is adjustable into: (1) a first engagement position where the first apparatus extends through the first opening in the support assembly and is received within the first groove in the axle; and, (2) a neutral position where the first apparatus is not received within the first groove;
wherein when the first apparatus is in the first engagement position, rotation of the first end of the axle by the associated input component in the first rotational direction causes the second end of the axle to provide to the associated output component with a first linear motion input in the first linear direction; and,
wherein when the first apparatus is in the neutral position, rotation of the first end of the axle by the associated input component in the first rotational direction causes the second end of the axle to provide to the associated output component no linear motion input.

8. The power transfer device of claim 7 wherein:
the first groove is substantially oval shaped and extends 360 degrees around the axle;
when the first apparatus is in the first engagement position, rotation of the first end of the axle by the associated input component in the first rotational direction for a first 180 degrees causes the second end of the axle to provide to the associated output component with the first linear motion input; and,
when the first apparatus is in the first engagement posit on, rotation of the first end of the axle by the associated input component in the first rotational direction for an additional 180 degrees causes the second end of the axle to provide the associated output component with a second linear motion input in a second linear direction that is substantially opposite to the first linear direction.

9. The power transfer device of claim 7 wherein:
the first groove: (1) extends 360 degrees around the axle; (2) has a first portion that is angled with respect to the line; and, (3) has a second portion that is not angled with respect to the line;
when the first apparatus is in the first engagement position, rotation of the first end of the axle by the associated input component in the first rotational direction while the first apparatus is received in the first portion of the first groove causes the second end of the axle to provide the associated output component with the first linear motion input; and,
when the first apparatus is in the first engagement position, rotation of the first end of the axle by the associated input component in the first rotational direction while the first apparatus is received in the second portion of the first groove causes the second end of the axle to provide the associated output component with no linear motion input.

10. The power transfer device of claim 7 wherein:
the support assembly comprises a second opening;
the first groove is angled at an angle A with respect to the line;
the axle has a second groove on its outer surface that is angled at an angle B with respect to the line that is significantly different than angle A;
a second apparatus is adjustable into a second engagement position where the second apparatus extends through the second opening in the support assembly and is received within the second groove in the axle;
when the first apparatus is in the first engagement position, rotation of the first end of the axle by the associated input component in the first rotational direction causes the second end of the axle to provide the associated output component with the first linear motion input a first linear amount; and,
when the second apparatus is in the second engagement position, rotation of the first end of the axle by the associated input component in the first rotational direction causes the second end of the axle to provide the associated output component with a second linear motion input in the first linear direction a second linear amount that is significantly different than the first linear amount.

11. The power transfer device of claim 10 wherein:
the support assembly comprises third and fourth openings;
the axle has a third groove on its outer surface, wherein at least a portion of the third grove is angled at an angle C with respect to the line that is significantly different than angle A and angle B;
the axle has a fourth groove on its outer surface, wherein at least a portion of the fourth groove is angled at an angle D with respect to the line that is significantly different than angle A and angle B and angle C;
a third apparatus is adjustable into a third engagement position where the third apparatus extends through the third opening in the support assembly and is received within the third groove in the axle;
when the third apparatus is in the third engagement position, rotation of the first end of the axle by the associated input component in the first rotational direction causes the second end of the axle to provide the associated output component with a third linear motion input in the first linear direction a third linear amount that is significantly different than the first and the second linear amounts;
a fourth apparatus is adjustable into a fourth engagement position where the fourth apparatus extends through the fourth opening in the support assembly and is received within the fourth groove in the axle; and,
when the fourth apparatus is in the fourth engagement position, rotation of the first end of the axle by the associated input component in the first rotational direction causes the second end of the axle to provide the associated output component with a fourth linear motion input in the first linear direction a fourth linear amount that is significantly different than the first and the second and the third linear amounts.

12. The power transfer device of claim 7 wherein:
the first end of the axle is suitable to receive an input from an associated internal combustion engine.

13. The power transfer device of claim 7 wherein the power transfer device further comprises:
a pendulum arm that extends from the first end of the axle;
a pendulum weight secured to a distal end of the pendulum arm;
wherein the first end of the axle has a handle that is suitable to receive a manual input from an associated person; and,
wherein the second end of the axle is suitable to provide an output to an associated piston pump.

14. A power transfer device comprising:
a support assembly;
a bearing assembly supported to the support assembly;
an axle that: (1) has first and second ends; (2) has a longitudinal axis; (3) is suitable to be rotated within the bearing assembly in a first rotational direction; (4) is suitable to be longitudinally moved within the bearing assembly in a first linear direction; and, (5) has a first groove on its outer surface, wherein at least a portion of the first groove is angled at an angle A with respect to a line that: (a) intersects the longitudinal axis of the axle and; (b) is perpendicular to the longitudinal axis of the axle;
wherein the first end of the axle is suitable to receive an input from an associated input component;
wherein the second end of the axle is suitable to provide an output to an associated output component;
wherein a first apparatus is adjustable into a first engagement position where the first apparatus is received within the first groove in the axle;
wherein when the first apparatus is in the first engagement position, rotation of the first end of the axle by the associated input component in the first rotational direction causes the second end of the axle to provide to the associated output component a first linear motion input in the first linear direction a first linear amount; and
wherein the absolute value of angle A is significantly greater than 0 degrees and the first linear amount is significantly greater than 0.

15. The power transfer device of claim 14 wherein:
the first groove has a first segment that is angled at angle A and a second segment that is angled at an angle B that is substantially 0 degrees with respect to the line;
wherein when the first apparatus is in the first engagement position, rotation of the first end of the axle by the associated input component in the first rotational direction while the first apparatus is received in the first segment of the first groove causes the second end of the axle to provide to the associated output component the first linear motion input; and,
wherein when the first apparatus is in the first engagement position, rotation of the first end of the axle by the associated input component in the first rotational direction an additional rotational amount while the first apparatus is received in the second segment of the first groove causes the second end of the axle to provide to the associated output component no linear input.

16. The power transfer device of claim 14 wherein:
the first groove has a first segment that is angled at angle A and a second segment that is angled at an angle −A with respect to the line;
wherein when the first apparatus is in the first engagement position, rotation of the first end of the axle by the associated input component in the first rotational direction while the first apparatus is received in the first segment of the first groove causes the second end of the axle to provide to the associated output component the first linear motion input; and,
wherein when the first apparatus is in the first engagement position, rotation of the first end of the axle by the associated input component in the first rotational direction an additional rotational amount while the first apparatus is received in the second segment of the first groove causes the second end of the axle to provide to the associated output component a second linear motion input in a second linear direction that is substantially opposite the first linear direction the first linear amount.

17. The power transfer device of claim 14 wherein:
the first groove has a first segment that is angled at angle A and a second segment that is angled at an angle B with respect to the line;
wherein angle B is substantially greater than angle A;
wherein when the first apparatus is in the first engagement position, rotation of the first end of the axle by the associated input component in the first rotational direction while the first apparatus is received in the first segment of the first groove causes the second end of the axle to provide to the associated output component the first linear motion input; and,
wherein when the first apparatus is in the first engagement position, rotation of the first end of the axle by the associated input component in the first rotational direction an additional rotational amount while the first apparatus is received in the second segment of the first groove causes the second end of the axle to provide to the associated output component a second linear motion input in the first linear direction a second linear amount that is significantly greater than the first linear amount.

18. The power transfer device of claim 14 wherein:
the axle has a second groove on its outer surface that is at least partially angled at an angle B with respect to the line;
wherein angle B is significantly different that angle A;
wherein a second apparatus is adjustable into a second engagement position where the second apparatus is received within the second groove in the axle; and,
wherein when the second apparatus is in the second engagement position, rotation of the first end of the axle by the associated input component in the first rotational direction causes the second end of the axle to provide to the associated output component a second linear motion input a second linear amount.

19. The power transfer device of claim 18 wherein:
a guide pin is used as the first and second apparatuses.

20. The power transfer device of claim 18 wherein:
a first guide pin is used as the first apparatus; and, a second guide pin is used as the second apparatus.
